(19) United States
(12) Patent Application Publication
(10) Pub. No.: US 2005/0240408 A1
(43) Pub. Date: Oct. 27, 2005

(54) Method and apparatus for entering verbal numerals in electronic devices

(76) Inventors: Jaime H. Redin, Manhattan Beach, CA (US); Maria S. Redin, Manhattan Beach, CA (US)

Correspondence Address: GENE W. ARANT, P.O. BOX 269, LINCOLN CITY, OR, 97367-0269, US

(21) Appl. No.: 11/107,692

(22) Filed: Apr. 14, 2005

Related U.S. Application Data
(60) Provisional application No. 60/564,797, filed on Apr. 22, 2004.

(51) Int. Cl. G10L 15/04

(52) U.S. Cl. 704/251

(57) ABSTRACT

A method used to process verbal numerals corresponding to major spoken languages entered in an electronic device that accepts input from a keyboard, a digitizer device configured to receive handwritten input, or a voice recognition device configured to interpret a set of voice words or commands; convert the verbal numeral into a decimal numeral; display the result of the conversion after each symbol of the verbal numeral is entered; and feed the converted number to the device or application once the last symbol of the verbal numeral has been entered.

This application claims priority of our Provisional Application Ser. No. 60/564,797, filed Apr. 22, 2004.

### FIELD OF THE INVENTION

The present invention relates to a general number-entry method designed to enter numeric quantities expressed as verbal numerals in any electronic device configured to receive input by using voice recognition, gesture recognition, keystrokes, handwritten pen strokes, or any other user input interface.

### DESCRIPTION OF THE PRIOR ART

Input means that are used in electronic devices such as computers, calculators and digitizer devices have number-entry keys or sets of symbols corresponding to numeric handwritten data used to enter a number. Said input means include a set of 10 number-entry keys or symbols corresponding to the “0” to “9” digits. The use of voice recognition and gesture recognition also includes support for words or gestures that represent digits and numbers in general.

As shown in U.S. Pat. No. 5,623,433, numbers are structured entities whose “numerical structures” are closely related with the way a number is expressed orally and can be used to represent a number by using a uverbal numeral, instead of a decimal numeral. These verbal numerals are combinations of digits and symbols, where said symbols represent the numerical structures in a given language. Before writing down or typing a number into a keyboard, a person needs to convert mentally the number into the correct sequence of digits; this sequence does not correlate with the way the number is conceived mentally or expressed verbally. For example, when thinking of the number “two thousand three” a person does not think on the sequence of digits “2”, “0”, “0” and “3”. Instead, the person conceives the number as the combination of two “thousand” numerical structures, plus the quantity “three.”

Notice that the advantages of using verbal numerals instead of decimal numerals as a means to enter numbers in numerical devices are already explained in U.S. Pat. No. 5,623,433.

U.S. Pat. No. 5,623,433, although it provides a particular method, does not provide a general method that can be used in any electronic device, independent of the nature of the input means available in the electronic device to enter a number expressed as a verbal numeral into the device.

The algorithms provided in U.S. Pat. No. 5,623,433 are oriented to major western languages, such as English, French, Spanish, where the numerical structures “hundred,” “thousand” and “million” are the basis for the verbal expression of a number, and does not support the major Asian languages such as Japanese, Chinese and Korean, where the numerical structures, “hundred,” “thousand” and “ten-thousand” (in Japanese called “man”) are used for the same purpose.

The algorithms provided in U.S. Pat. No. 5,623,433 do not support the usage of combined numerical structures that would allow entering numbers larger than the order of millions, such as “billions” and “trillions” unless a symbol is assigned to them in the construction of the verbal numbers. Assigning a symbol for these large numerical structures has the disadvantage of requiring additional input keys when a keyboard is used as input means, and also it has the disadvantage that in English, the numerical structure “billion” has a different meaning in England and in the United states.

### SUMMARY OF THE INVENTION

The present invention provides a method to enter numbers expressed as verbal numerals in any electronic device, or computer application.

Several objects and advantages of the present invention are:

(a) To provide a general procedure that can be used to enter a verbal numeral in any electronic device or computer application, where said procedure is able to support any input means used the enter or dictate a number.

(b) To provide a general algorithm able to support the conversion of a verbal numeral into a decimal numeral for any human language that has a way to express numerical quantities in a mode consistent with the “Verbal Numerical Expressions” described in the appendix of U.S. Pat. No. 5,623,433.

(c) To provide support for the usage of combined numerical structures as an alternative way to represent a verbal numeral when symbols for very large numerical structures such as “billion,” “trillon,” “milliard,” “oku” and “cho” (“oku” and “cho” are the Japanese numbers for the numerical structures 10\hat{ }8 and 10\hat{ }12, respectively) are not directly available on the input means of an electronic device; for example, the numerical structure “billion” could be represented as the combination “thousand-million” in the United States, or as “million-million” in England. This has the advantage of allowing a user to enter very large numbers even when, because of practical limitations or inconsistency in the word used to express a given numerical structure, only symbols for the main numerical structures (for example, “hundred,” “thousand” and “million”) have been provided.

(d) To provide a method where the verbal numeral being entered by a user, and the decimal number corresponding to said verbal numeral, are stored in a verbal number buffer, and a decimal number buffer, respectively, while the number is being entered, and showing the contents of the decimal number buffer in some output means, such as a window or display, if such output means are available, until the last symbol of the verbal numeral is entered, and then passing the decimal number stored in the memory buffer to the application or logic built in the electronic device. In addition to the generality of its approach, this method has the advantage of allowing computer programs and applications, such as word processing or spreadsheet applications, to accept verbal numerals even if they were not designed originally to accept numbers expressed as verbal numerals.

(e) To provide a symbol “X#” or equivalent to allow the user to toggle the number-entry procedure between accepting verbal numeral components and accepting only digits as in the conventional number-entry procedures at any time during or before starting a number-entry operation.

(f) To provide a symbol “Calc” or equivalent to allow the user to further manipulate the number by activating a calculator application while the number is still stored in the verbal numeral buffer, before passing the number to the main windows application, if the electronic device is a computer able to handle windows based applications.

Still further objects and advantages will become apparent from the consideration of the ensuing description and drawings.

In order to achieve the objects of the present invention, there is provided input means designed to receive the symbols corresponding to the digits and numerical structures available in a given language, and also, if required, the symbols corresponding to the “X#” and “Calc” functionality.

If the input device is a keyboard or a program that emulates a keyboard, then one key will be used as an input means for each digit, one such means for each numerical structure that is to be used, one such means for the “X#” symbol, and one such means for the “Calc” symbol.

If the input device is a digitizer configured to receive handwritten input, then one sequence of handwritten strokes will be used as an input means for each digit, one such means for each numerical structure that is to be used, one such means for the “X#” symbol, and one such means for the “Calc” symbol.

If the input device is a microphone configured to receive verbal input, then it may be necessary to allow for the possibility that more than one word may be associated with a digit, numerical structure, the “X#” function, or the “Calc” function. Then any one of several alternative words will be used as an input means for each digit or number smaller than the smallest available numerical structure, any of such means for each corresponding numerical structure used in the human language, any of such means for the functionality of the “X#” symbol, and any of such means for the functionality of the “Calc” symbol.

If the input device is configured to recognize any of a known set of gestures or other user activity as user input, then those recognized gestures or other user activity will serve as input means for the corresponding digits or numbers smaller than the smallest available numerical structure, any of such means for each corresponding numerical structure available in the corresponding human language, any of such means for the functionality of the “X#” symbol, and any of such means for the functionality of the “Calc” symbol.

In addition to the input means, the device will have a decoding logic, able to convert the sequence of digits and/or numerical structures entered by the user into its corresponding decimal numeral. The device may also have a window to display the converted decimal numeral, and means to detect when the number-entry procedure has been completed.

With the above arrangement, to input a number the user can either enter the sequence of digits corresponding to the decimal representation of the number, or enter a combination of smaller numbers and numerical structures corresponding to a valid verbal numeral. For example, to enter the number, “twenty-three million one thousand two hundred and seven” in a keyboard-based device designed to accept verbal numerals corresponding to the English language numerical structures, where keys with symbols [H], [T], and [M] have been provided to represent the numerical structures “hundred,” “thousand” and “million,” respectively, the user can enter the sequence of digits corresponding to its decimal numeral: “23001207” or a combination of smaller numbers and numerical structures corresponding to its verbal numeral: “23M1T2H7”. The same number in Japanese would be pronounced “Nisen samhyaku man issen nihyakunana”, and would require keys corresponding to the Japanese numerical structures; for example, if the symbols [h], [s], [m] representing the numerical structures “hyaku” for 100, “sen” for 1000, and “man” for 10000, respectively, are available, the user could enter the following verbal numeral: 2s3hmls2s7. To better understand this last example, some spacing has been included between some word components, that are not necessarily used in the actual written form of the number, and the numerical structures have been written with bold letters; also notice that the word components “ni,” “sam,” “is,” and “nana” corresponds to the digits 2, 3, 1, and 7, respectively.

By using the method described in this patent, if the device has voice recognition capabilities, where each of the numbers smaller than 100 has been assigned a unique word, and where the numerical structure 100 has been assigned the words “hundred” or “hundreds,” and the numerical structure 1,000 has been assigned the words “thousand” or “thousands,” and the numerical structure 1,000,000 has been assigned the words “million” or “millions,” a user could enter the number given in the example provided above as: “twenty-three millions one thousand two hundred seven” or “two three million one thousand two zero seven.” With the same arrangement, a user could enter the number “five billion three hundred” by speaking the following words to the input device: “five thousand millions three hundred” if in the United States, or “five million millions three hundred” if in England. The same approach can also be used to support multiple languages within the same implementation of the method by assigning the word equivalents for each digit, small numbers and numerical structures corresponding to the different languages supported, to the extent that the supported languages use the same numerical structures.

Each time the user enters a digit or a numerical structure, the partial verbal numeral will be stored in a verbal numeral buffer and a decoding algorithm provided with the device will convert the partial verbal numeral into its decimal numeral. The converted decimal representation of the number will be stored in a decimal number buffer, and may be displayed in the window or display screen provided for this purpose. As an example, the following sequence of keystrokes within a word processing program will appear to the user as follows:

| Keystrokes | Screen display |
|---|---|
| The year was 2 | The year was 2 |
| [T] | The year was 2000 |
| 1 | The year was 2001 |

At this point, the verbal numeral buffer stores the verbal numeral sequence [2][T][1], and the decimal number buffer stores the digits sequence [2][0][0][1], but the word processing application has received only the following sequence of keystrokes: “The year was ”. The “2001” portion is actually displayed in a borderless window controlled by the keyboard driver. It won't be until the user enters a delimiter keystroke such as the space key that the keyboard driver will remove the borderless window and send the “2001” sequence of digits to the word processing application.

To provide additional flexibility, the “X#” input means can be used to toggle the device so that it will thereafter either accept only digits or else accept both digits and verbal, including in the middle of a number-entry operation. When toggled to accept only digits, the numerical structures functions will serve as means for entering multiple zeroes and will generate a number of zeroes corresponding to the associated power of ten; for example, the “thousand” structure will generate a sequence of three zeroes that will be appended to the number being entered.

Also, the “Calc” input means can be used if the method is applied in a computer environment to activate a calculator application showing the number stored in the decimal number buffer ready to be further manipulated by the calculator application before being passed to the device or application. If the decimal buffer is empty at the time the calculator application is activated, the calculator will start with an empty initial value, as is done by a standard calculator.

### DRAWING FIGURES

In the drawings, closely related figures are identified by the same number but different alphabetic suffixes.

FIG. 1 is a layout showing a possible arrangement of a computer keyboard able to accept verbal numerals according to the sample embodiment described in the present invention.

FIG. 2a is a block diagram showing the arrangement of the physical and logical components of conventional computer keyboards. The purpose of the keyboard driver program is to translate the digital signals sent by the keyboard when a key is pressed into its corresponding ASCII or control code, and then send that information to the input channel of the active application, which in turn interacts with the information displayed in the application window.

FIG. 2b is a block diagram showing an arrangement of the physical and logical components required to support the buffered number-entry procedure described the sample embodiment of the present invention.

FIG. 3 is a flow chart explaining the logical operation of the keyboard driver according to the sample embodiment described in the present invention.

FIG. 4 is a flow chart showing a procedure to convert the verbal numeral stored in a segment of the verbal numeral buffer into its corresponding decimal number according with the sample embodiment described in the present invention.

### DETAILED DESCRIPTION OF A SAMPLE EMBODIMENT

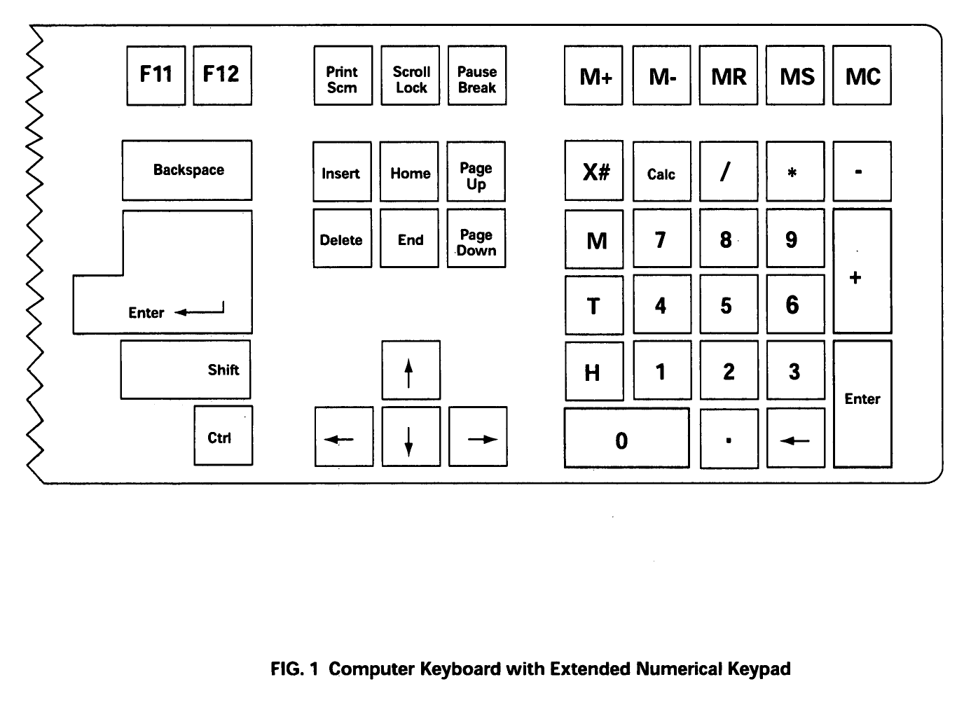

Although the input means and methods object of this invention can be applied to any input device or computer program that accepts numbers as part of its operation, the example embodiment provided here is the description of an extended computer keyboard designed to be used with an English subset of numerical structures configured to accept verbal numerals for any program application, such as a spreadsheet or word processing application that may or may be not be specifically programmed to accept verbal numerals. This sample embodiment will be described with reference to FIGS. 1, 2b, 3 and 4.

FIG. 1 shows a preferred arrangement of the numerical keypad of a computer keyboard. In addition to the standard keys, the numerical keypad, as described in the present invention must have at least three numerical structure keys: hundred key [H], thousand key [T], million key [M], and one extended number key [X#] to allow the user to swap the mode between conventional and structured mode.

The actual implementation of the numerical keypad may differ depending on the ergonomic approach used by a given manufacturer, for example, the symbols “H”, “T”, “M” used in the key-tops of FIG. 1 may be replaced by symbols “00”, “000” and “0x6” to make them language independent, or they may be placed horizontally above the digit keys array. Other sets of numeric structure keys may be used to accommodate other languages.

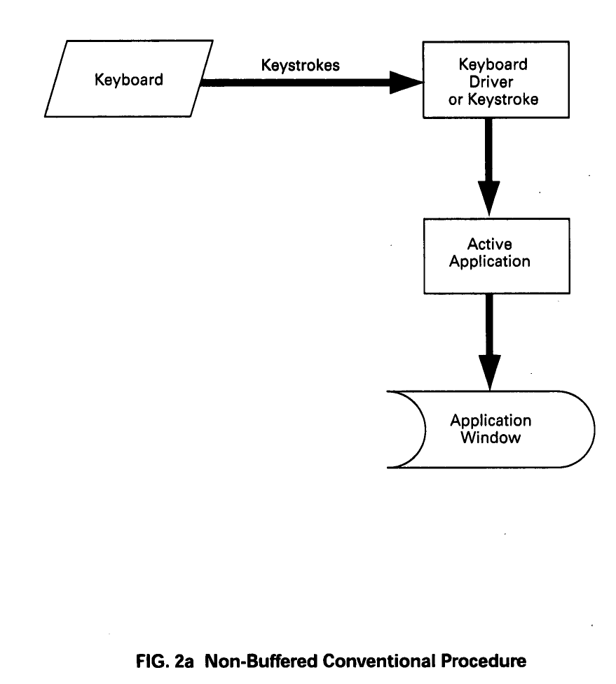

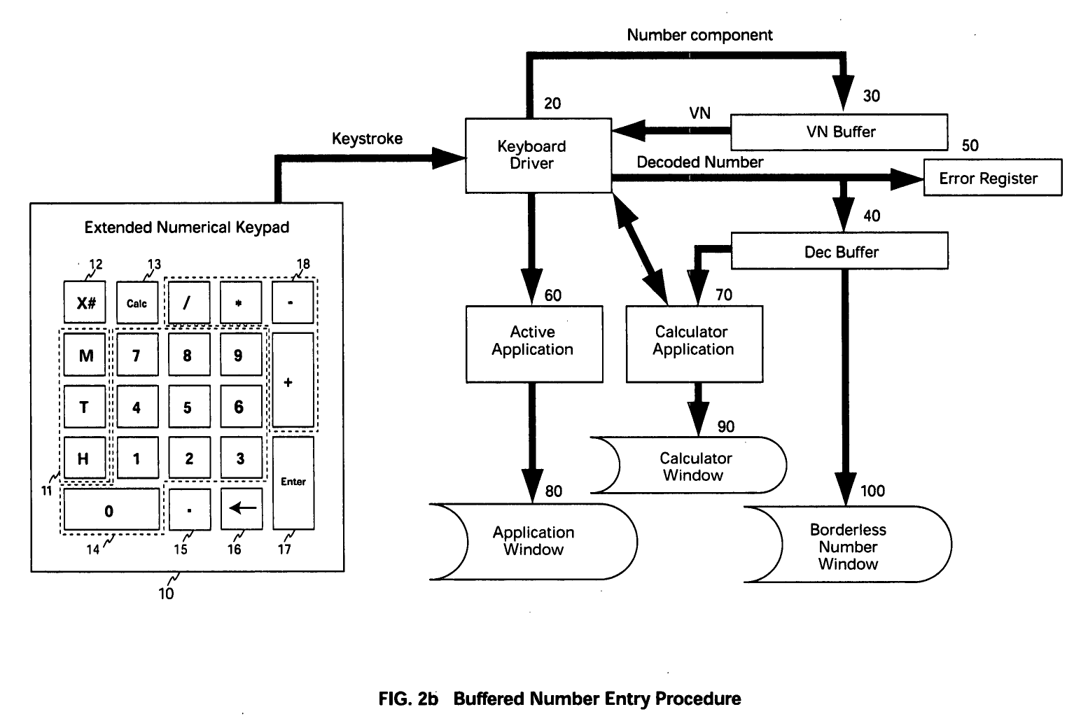

Referring to FIG. 2b, an arrangement of the numerical keypad suitable for the embodiment of the present invention will be described.

A keyboard 10 with an array of keys including at least three structure keys 11: hundred key [H], thousand key “P” and million key [M]; one extended number key 12 [X#]; a calculator key 13 [Calc]; ten digit keys 14 [0] to [9], one decimal point key 15 [.]; a [backspace] key 16 used to delete the last symbol entered by the user; an [Enter] key 17, and a set of arithmetic operator keys 18 that can be used to perform operations on the number being entered.

Keyboard 10 is provided to perform a number-entry operation in structured or conventional mode.

[X#] key 12 is provided to toggle the status of the numerical keypad between conventional and structured mode. When the numeric keypad is in structured mode, structure keys 11 are provided to enter the numeric structures hundred, thousand and/or million in combination with the digits entered by using digit keys 14 into the verbal numeral buffer 30. When the numeric keypad is in conventional mode or when a non-numeric value is being entered, structure keys 11 are provided to enter a sequence of two, three or six multi-zeroes. Decimal point key 15 is provided to enter a period, or to start the entry of the decimal part of a number.

Calculator key 13 [Calc] is provided to activate a calculator application 70 and a calculator window 90 that allows additional manipulation of the numerical value stored in the decimal number buffer 40 during a number-entry procedure.

Keyboard driver 20 and/or microprocessor logic is used to process the keystrokes coming from the numerical keypad 10 according to the functionality described in this patent.

Verbal numeral buffer 30 is used to store the sequence of digits and/or numerical structures entered during a number-entry procedure while the [X#] key is set to structured mode. Decimal number buffer 40 is used to store the sequence of digits and decimal point, if required, that corresponds to the decimal representation of the verbal numeral stored in the verbal numeral buffer.

Borderless number window 100 is used to display the contents of the decimal number buffer during a number-entry procedure. Any value stored in the decimal number buffer 40 is also displayed in the number window 100 that is a borderless window preferably located at the cursor position of the active application window 80 and using the same font and background characteristics of the application window 80.

Error register 50 is used to store the error status of the procedures performed by keyboard driver 20. The keyboard driver 20 uses error register 50 to qualify if a new keystroke entered by the user corresponds to a valid verbal numeral.

Operation

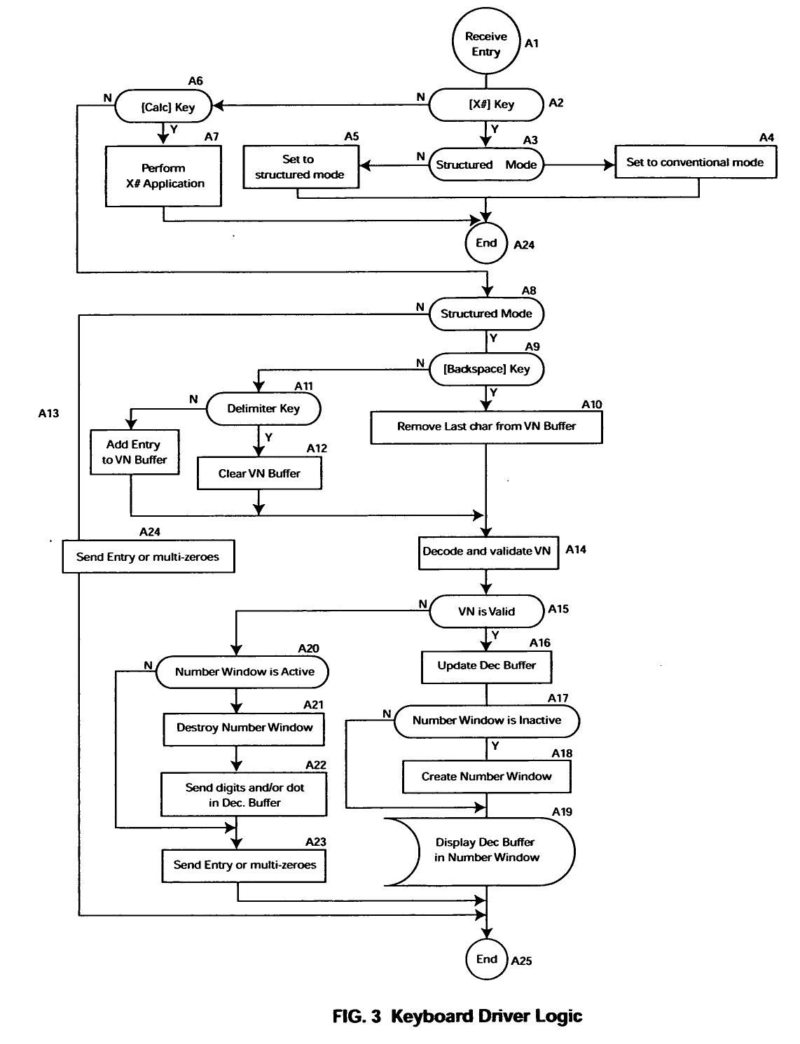

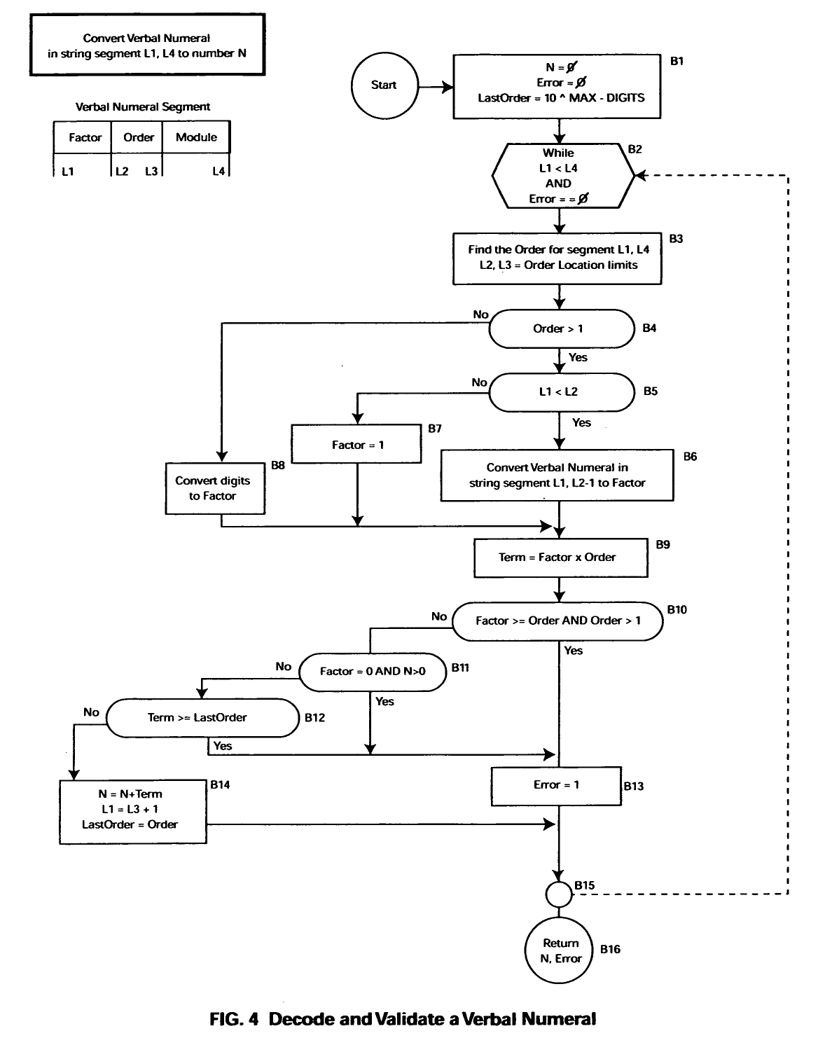

Operation of the computer keyboard with the above arrangement will be described with reference to the block diagram in FIG. 2b and the flow charts shown in FIG. 3 and FIG. 4.

In step A1, the keyboard driver reads a signal sent by the keyboard, and converts this entry into an ASCII code or control code; the control flow advances to step A2. In step A2, it is determined if the entry code corresponds to the [X#] key; if this is true the control flow advances to step A3, otherwise it advances to step A6.

In step A3, it is determined if the numerical keypad is in structured mode; if this is true the control flow advances to step A4, otherwise it advances to step A5. In step A4, the numeric keypad is set to conventional mode, and then the control flow advances to step A24. In step A5, the numeric keypad is set to structured mode, and then the control flow advances to step A24.

In step A6, it is determined if the entry code corresponds to the calculator key [Calc]; if this is true the control flow advances to step A7, otherwise it advances to step A8.

In step A7, the keyboard driver launches a calculator application window, and then the control flow advances to step A24. In step A8, it is determined if the numerical keypad is in structured mode; if this is true the control flow advances to step A9, otherwise it advances to step A24.

In step A9, it is determined if the entry code corresponds to the [Backspace] key; if this is true the control flow advances to step A1, otherwise it advances to step A11. In step A10, one character is removed from the right side position of the verbal numeral buffer, and then the control flow advances to step A14.

In step A11, it is determined if the entry code corresponds to a delimiter key, where delimiter key is any key, such as the space key, that is not a digit [0] to [9], a decimal point [.], a structure key [H], [M] or [T], or an alphabetic key [a] to [x] or [A] to [X]; if this is true the control flow advances to step A12, otherwise it advances to step A13.

In step A12, the content of the verbal numeral buffer is cleared out, and then the control flow advances to step A14. In step A13, the entry code is appended to the verbal numeral buffer, and then the control flow advances to step A14.

In step A14, the conversion algorithm described in FIG. 2b is applied to convert the verbal numeral stored in the verbal numeral buffer 30 into a decimal number. The conversion algorithm also checks the validity of the sequence of codes stored in the verbal numeral buffer 30 and updates the contents of error register 50 accordingly. An empty buffer will be considered to be an invalid verbal numeral. Then, the control flow advances to step A15.

In step A15, it is determined if the conversion performed in step A14 yielded a valid decimal number by reviewing the contents of error register 50; if this is true the control flow advances to step A16, otherwise it advances to step A20. In step A16, the valid decimal number decoded in step A14 is stored in the decimal number buffer 40, and then the control flow advances to step A17.

In step A17, it is determined if the number window 100 is inactive; if this is true the control flow advances to step A18, otherwise it advances to step A19. In step A18, a new number window 100 is created. Then the control flow advances to step A19.

In step A19, the value stored in the decimal buffer 40 is displayed in number window 100 on the active application 80. Then, the control flow advances to step A25. In step A20, it is determined if number window 100 is active; if this is true the control flow advances to step A21, otherwise the control flow advances to step A23.

In step A21, the number window 100 is removed. Then, the control flow advances to step A22. In step A22, the characters stored in decimal number buffer 40 are sent to the active application 80. Then the control flow advances to step A23.

In step A23, the entry character, or the corresponding sequence of multi-zeroes if the entry is a structure key, is sent to the active application 80. At this point, the numerical structures “hundred,” “thousand,” and “million” are interpreted as “00”, “000” or “000000”. Then the control flow advances to step A25.

In step A24, the entry character, or the corresponding sequence of multi-zeroes if the entry is a structure key, is sent to the active application 80. Then the control flow advances to step A25. In step A25, the keyboard driver 20 waits for another entry signal generated by the keyboard 1.

Conversion of a Verbal Numeral into a Number

The algorithm applied to convert the verbal numeral stored in the verbal numeral buffer 30 into a number is a recursive procedure supported by the theory described in the Appendix of U.S. Pat. No. 5,623,433, and is based in the algorithm described in Claim 1 of said Patent. The basic algorithm has been expanded to support combined numerical structures and error detection. An example of an implementation of this algorithm will be described with reference to the flow-chart shown in FIG. 4.

The term “Order” has already been defined in Appendix of U.S. Pat. No. 5,623,433, however, in order to support the combined numerical structures referred to in this invention, the “Order” parameter of a verbal numeral is now being redefined as a sequence of one or several consecutive numerical structure symbols where the value of each numerical structure symbol is equal to or larger than the value of its preceding numerical structure symbol.

As examples of applying this concept, the following numerical structures may be defined by using the “hundred (H),” “thousand (T)” and “million (M)” numerical structures:

TM American “billion” or French “milliard” (10\hat{ }9)

MM English and French “Billion” or Japanese “cho” (10\hat{ }12).

HH Japanese “man” (10,000)

HT Japanese “oku” (10\hat{ }8)

As another example, the English version of the number “two billion three hundred million” may be entered with the following verbal numeral: 2MM3HM. The algorithm should identify these types of sequences within the verbal numeral and consider them as single composite numerical structures.

All variables referred in the following description are memory cells in the keyboard driver program 20, and it is assumed that the verbal numeral buffer is stored in memory in a way such that that each of the individual components of the verbal numeral can be addressed individually or in groups named “segments”, where a segment may include either all the components of the verbal numeral or one subsequence of the verbal numeral. The numerical value N is the decimal equivalent of the converted verbal numeral. The conversion procedure requires finding the location of the verbal numeral's Order within the segment of the verbal numeral that is being converted. L1 and L4 represent the location of the first and last symbols in the segment of the verbal numeral buffer being converted and are passed as arguments to the algorithm; for example, if the segment would include all the stored symbols, L1 would be equal to 1 and L4 would be equal to the number of symbols stored in the verbal numeral buffer 30. L2 and L3 are the beginning and ending location of the numerical structure or combined numerical structure that corresponds to the Order of the verbal numeral, and the variable “Order” contains the value of said Order. “Error” is a variable that contains 0 if the conversion algorithm determines that the segment being analyzed contains a valid verbal numeral, otherwise it is assigned a value greater than 0. “LastOrder” is a variable used for the purpose of the validation logic, and is used to store the value of the last Order found during the recursive procedure. “Factor” and “Term” are variables used to store intermediate results of the calculations.

In step B1 variables N and “Error” are initialized to 0, and “LastOrder” is initialized to 10 to the power of MAX_DIGITS, where MAX_DIGITS is the maximum number of digits that can have the converted numerical value N. Then the control flow advances to step B2.

In step B2 a loop operation is started, and is repeated as long as L1 is less than L4 and “Error” is equal to 0. The steps included in the loop include steps B3 through B14. In step B3 the “Order” of the string segment delimited by locations L1 and L4 is determined, and the values of L2 and L3 are retrieved. If the segment does not contain any numerical structures, then the variables L2 and L3 will be assigned the value L4+1, and the “Order” will be assigned the value 1 (which is 10\hat{ }10 ) in order to indicate that the segment contains no numerical structures.

In step B4, it is determined if the value of variable “Order” is greater than 1; if this is true the segment contains numerical structures and the control flow advances to step B5, otherwise the segment only contains digits and the control flow advances to step B8. In step B5, it is determined if the value of variable L1 is less than the value of variable L2; if this is true the control flow advances to step B6, otherwise it is an indication that the digit 1 has been defaulted by the user, as when, for example, H is entered instead of 1 H to mean “one hundred” and the control flow advances to step B7.

In step B6, a recursive call is made to this algorithm in order to convert the verbal numeral located at the left of the numerical structures that represent the order of the verbal numeral being analyzed (the segment that follows location L1 and preceeds L2-1) and the result is stored in variable “Factor.” Then the control flow advances to step B9.

In step B7, the value of variable “Factor” is set to 1. This is done to enter as a factor the value defaulted by the user. Then the control flow advances to step B9.

In step B8, the value corresponding to the sequence of digits containing no numeric structures is stored in variable “Factor.” Then, the control flow advances to step B9.

In step B9, the variable “Term” is computed as the result of multiplying the “Factor” by the “Order.” Then, the control flow advances to step B10. In step B10, it is determined if the “Factor” is greater or equal than the order when the “Order” is greater than 1; if this is true, then an error condition has been detected and the control flow advances to step B13, otherwise the control flow advances to step B11.

In step B11, it is determined if the “Factor” is greater is equal to 0 when the number N is greater than 0; if this is true, then an error condition has been detected and the control flow advances to step B13, otherwise the control flow advances to step B12. In step B12, it is determined if the “Term” is greater or equal than the value stored in the “LastOrder;” if this is true, then an error condition has been detected and the control flow advances to step B13, otherwise the control flow advances to step B14.

In step B13, the value of variable “Error” is set to 1 in order to indicate that an invalid verbal numeral has been found. Then the control flow advances to step B15.

In step B14, the value of N is computed by adding to the previous value of N the value of “Term.” Then, L1 is assigned the value in L3+1 in order to repeat the procedure for the module of the verbal numeral, and the value of “Order” is stored in variable “LastOrder” in order to prepare for testing the condition described in step B12. Then the control flow advances to step B15.

In step B15, the conditions defined in step B2 are tested; if both are true, then control flow returns to steps B3, otherwise, the control advances to step B16.

In step B15, the procedure ends by returning the value of variables N and “Error.”

### SUMMARY, RAMIFICATIONS, AND SCOPE

Electronic devices or computer programs configured to receive keystrokes, handwritten input, voice input, or gestures input, will give users greater flexibility in number-entry operations when given the capability to accept verbal numerals in addition to the decimal numerals normally provided for this type of operation.

The usage of verbal numerals as described in this patent has several advantages over the conventional number-entry methods and over the method described in U.S. Pat. No. 5,623,433:

(a) it supports verbal numerals that include combined numerical structures used to represent numerical structures larger than the ones available in the device input means;

(b) it provides additional flexibility even in situations where a given application has not been specially designed to accept this type of input;

(c) it supports verbal numerals that include symbols corresponding to numerical structures available in Asian languages;

(d) it supports the usage of an “X#” symbol that provides additional flexibility to the number-entry procedure by allowing the toggle of the number-entry procedure between structured and conventional procedures at any time during the number-entry operation;

(e) it supports the usage of a “Calc” symbol that provides additional on-line resources during a number-entry procedure by allowing to use a calculator application, if the nature of the electronic device allows for the usage of a calculator application, as a way to further manipulate the number during a number-entry operation.

Although the above description and the attached figures and examples contain several specifics, these should not be construed as limiting the scope of the invention but as merely providing illustrations of a sample implementation of this invention. For example, the layout, number, shape, size, symbols, and/or color of the structure keys shown in the sample embodiment described in this patent could be changed to improve the ergonomics or the appearance of the keyboard.

Similarly, the block arrangements presented in FIG. 2b and the algorithms and/or procedures presented in FIG. 3 and FIG. 4 as well as the actual instructions or program used to implement the method described in this patent could differ depending on the nature of the device, the technology used in its construction and the native language used by the potential user of the device or application. Thus, the scope of this invention should be defined by the appended claims and their legal equivalents rather than by the examples given.

1. A method for accepting verbal numerals into a device or application, comprised of:
(a) input means for receiving a sequence of digits and numerical structures corresponding to a verbal numeral;
(b) decoding the signals received by the input means into a symbol that represents a digit or a numerical structure, and passing the symbol to a driver program;
(c) adding the symbol to the previous symbols received for this number-input operation as part of a verbal numeral, and storing it in a verbal numeral buffer;
(d) converting each intermediate sequence of verbal numeral symbols into the sequence of digits that corresponds to the decimal representation of the verbal numeral, and storing the result in a decimal number buffer;
(e) displaying, if required, the contents of the decimal number buffer in a window or display controlled by the application, the device or the driver program; and
(f) feeding the contents of the decimal number buffer to the device or application once all the verbal numeral symbols have been entered.

2. The method of claim 1 wherein a numerical structure is a symbol that corresponds to the word used to represent a power of ten in a given human language.

3. The method of claim 2 wherein larger numeric structures can be formed by combining symbols of smaller numeric structures in such a way that each symbol corresponds to a numerical structure with a value larger or equal to the value of the immediately preceding numerical structure.

4. The method of claim 1 wherein a key in the keyboard corresponds to each available numerical structure.

5. The method of claim 1 wherein a pen input event in the digitizer corresponds to each available numerical structure.

6. The method of claim 1 wherein one or several alternative words spoken to the voice recognition device corresponds to each available numerical structure.

7. The method of claim 1 wherein one or several alternative gestures made in front of a gesture sensor device corresponds to each available numerical structure.

8. The method of claim 1 wherein a symbol is assigned, in addition to the verbal numeral components, to allow the numerical structures to be considered as multi-zero input components and prevent the use of the structured procedure at any time during the number-entry operation.

9. The method of claim 1 wherein a symbol is assigned, in addition to the verbal numeral components, to allow, if possible, activation of a calculator application to do further manipulation of the number being entered by the user.

10. The method of entering into an electronic device a decimal number that is to be initially expressed in a non-numeric manner, comprising the steps of:
(a) providing respective symbolic representations for the 1, 10, 100, 1000, and higher digital positions of decimal numbers;
(b) providing representations for the values from zero to nine, inclusive, that may be accorded to a particular digital position;
(c) entering a non-numeric representation for the digit of each digital position of the decimal number, so as to then produce in response thereto a corresponding symbolic representation;
(d) combining the symbolic representations of digital positions with corresponding representations for the value to be accorded to each associated digital position;
(e) visually displaying a result of the combining process; and
(f) then maintaining the visual display while continuing the combining process until the visually displayed result corresponds to the decimal number.

11. The method of claim 10 wherein the electronic device is then actuated to convert the decimal number into a binary number.

12. A method of entering into an electronic device a decimal number that is to be initially expressed in a non-numeric manner, comprising the steps of:
(a) assigning different symbols to correspond with respectively different digit positions of any decimal number;
(b) assigning different powers of ten to correspond with the respectively different digit positions in any decimal number;
(c) assigning representations of value from zero to nine, inclusive, for the value that any individual digit of a decimal number in any digit position may have;
(d) entering non-numeric information to produce both different symbols for the digital positions of the number, and the respective digit values of the number associated with those positions;
(e) combining the non-numeric information thus entered with the powers of ten corresponding to respective digit positions to produce a result;
(f) visually displaying the result of the combining process as it progresses; and
(g) then while continuing the combining process maintaining the visual display until the visually displayed result correctly corresponds to the digital number being inputted.

13. The method of claim 12 wherein the non-numeric information for respective digit values of the number is entered separately from digital position symbols.
